(19) United States
(12) Patent Application Publication
(10) Pub. No.: US 2026/0174225 A1
(43) Pub. Date: Jun. 25, 2026

(54) Shelf Load-Supporting Device

(71) Applicant: Kennister Daley, Boynton Beach, FL (US)

(72) Inventor: Kennister Daley, Boynton Beach, FL (US)

(21) Appl. No.: 19/201,130

(22) Filed: May 7, 2025

Related U.S. Application Data
(60) Provisional application No. 63/737,933, filed on Dec. 23, 2024.

(51) Int. Cl. A47B 57/20; A47B 96/02; F16B 7/10

(52) U.S. Cl. CPC A47B 57/20; A47B 96/021; F16B 7/105

(57) ABSTRACT

A shelf load-supporting device is provided. The device is comprised of an adjustable vertical bracing apparatus designed to transmit vertical loads directly from a wire shelf to the floor, thereby reinforcing the structural integrity of closet shelving systems. The device features a telescopic body that adapts to various shelf heights, supporting different garment lengths, and is secured in position using a locking mechanism that retains the desired extension. A rubber footing at the base provides stable, non-slip contact with diverse floor surfaces, while the upper receiving structure securely engages the underside of the shelf rib to prevent displacement. This upper fixture incorporates protective elements to avoid shelf damage and retention features to enhance load-bearing engagement.

### CROSS-REFERENCE TO RELATED APPLICATION

The present application claims priority to, and the benefit of, U.S. Provisional Application No. 63/737,933, which was filed on Dec. 23, 2024, and is incorporated herein by reference in its entirety.

### FIELD OF THE INVENTION

The present invention relates generally to the field of shelves. More specifically, the present invention relates to an adjustable vertical bracing apparatus designed to transmit vertical loads directly from a wire shelf to the floor. Accordingly, the present disclosure makes specific reference thereto. Nonetheless, it is to be appreciated that aspects of the present invention are also equally applicable to other like applications, devices, and methods of manufacture.

### BACKGROUND

In residential and commercial settings, wire shelves are commonly installed in closets due to their cost efficiency, ease of installation, and ventilation benefits. However, these wire shelving systems are often limited in their load-bearing capacity. When users hang numerous garments or place heavy items on these shelves, structural issues such as sagging, deflection, or complete shelf failure can occur. These failures not only damage the shelving units but may also result in damage to personal items and present safety hazards to individuals. The inability to store clothing efficiently due to the risk of shelf collapse leads to underutilization of available closet space. Additionally, many renters or temporary occupants face restrictions on making permanent alterations to closet infrastructure, limiting their ability to reinforce shelves with traditional mounting or support hardware. This presents a recurring issue in a wide variety of housing units, especially those relying on standardized, lightweight shelving. The absence of non-invasive support mechanisms forces users to compromise on organization, which impacts the overall utility of the closet system. Accordingly, a solution is needed to enhance the structural integrity of wire shelves without requiring permanent modifications or complex installation procedures.

Therefore, there exists a long-felt need in the art for a shelf load-supporting device that reinforces wire closet shelves subjected to the cumulative weight of hanging garments. There also exists a long-felt need in the art for a shelf load-supporting device that can be easily installed, adjusted, or removed without tools or permanent alteration to existing closet structures. Moreover, there exists a long-felt need in the art for a shelf load-supporting device that enables users to maximize closet storage capacity by minimizing the risk of shelf deflection or collapse.

The subject matter disclosed and claimed herein, in one embodiment thereof, comprises a shelf load-supporting device. The device is comprised of an adjustable vertical bracing apparatus designed to transmit vertical loads directly from a wire shelf to the floor, thereby reinforcing the structural integrity of closet shelving systems. The device features a telescopic body that adapts to various shelf heights, supporting different garment lengths, and is secured in position using a locking mechanism that retains the desired extension. A rubber footing at the base provides stable, non-slip contact with diverse floor surfaces, while the upper receiving structure securely engages the underside of the shelf rib to prevent displacement. This upper fixture incorporates protective elements to avoid shelf damage and retention features to enhance load-bearing engagement.

In this manner, the shelf load-supporting device of the present invention accomplishes all the foregoing objectives and provides an adjustable device that transmits vertical load directly from the shelf to the floor. The incorporation of a rubber footing ensures stability on various floor surfaces, while the top fixture engages securely with the underside of the shelf rib, preventing displacement. The device's telescopic feature accommodates shelves mounted at varying heights, supporting a wide range of garment lengths. The locking mechanism retains the rod at the desired extension, and optional leveling tools assist with proper alignment. Additionally, protective and retention features at the top interface prevent shelf damage and enhance load-bearing engagement. Therefore, the device offers a non-permanent, tool-free solution that reinforces shelf structure, thereby increasing the functional capacity of closets in residential and commercial environments.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a shelf load-supporting device. The shelf load-supporting device is a vertical bracing apparatus configured to reinforce and stabilize the front edge or other areas of a wire shelf, commonly used in closet systems. The device is designed to address sagging, deflection, or failure of the shelf caused by the cumulative weight of stored items by transmitting compressive loads from the shelf directly to the floor, thereby enhancing structural stability and alignment over time.

The device is comprised of a body that serves as the primary load-bearing component. The body is constructed as an adjustable telescopic rod, enabling extension and retraction to accommodate various shelf installation heights, supporting both low and high mounting positions without requiring modifications to existing shelving. At least one integrated locking mechanism secures the telescopic body at the desired length.

A first end of the body includes a non-slip rubber foot designed to provide stable contact with the floor. The foot may incorporate a concave or domed surface for optimized pressure distribution and may include grip enhancements such as ridges, treads, chevron patterns, or radial grooves to improve traction on various flooring types.

The device may feature an integrated leveling bubble positioned near the base or midsection of the body. This component enables vertical alignment during installation, thereby improving axial load transfer and overall structural performance.

A second end of the body is comprised of at least one receiving structure configured to engage the underside of the wire shelf. The receiving structure is shaped as a cradle-like bracket contoured to interface with the shelf. The receiving structure may further include retention features to enhance mechanical engagement with the shelf and that secure the device during use, particularly in environments subject to vibration or incidental contact.

The invention also includes a method of use involving placement of the device beneath the shelf, extension of the telescopic body to engage the shelf, actuation of the locking mechanism, visual verification of vertical alignment using the leveling bubble, and securing the receiving structure using at least one retention feature to ensure stable engagement.

Accordingly, the shelf load-supporting device of the present invention is particularly advantageous as it provides an adjustable device that transmits vertical load directly from the shelf to the floor. The incorporation of a rubber footing ensures stability on various floor surfaces, while the top fixture engages securely with the underside of the shelf rib, preventing displacement. The device's telescopic feature accommodates shelves mounted at varying heights, supporting a wide range of garment lengths. The locking mechanism retains the rod at the desired extension, and optional leveling tools assist with proper alignment. Additionally, protective and retention features at the top interface prevent shelf damage and enhance load-bearing engagement. In this manner, the device offers a non-permanent, tool-free solution that reinforces shelf structure, thereby increasing the functional capacity of closets in residential and commercial environments.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a shelf load-supporting device of the present invention while attached to a shelf in accordance with the disclosed architecture; and

FIG. 2 illustrates a flowchart of a method of using one potential embodiment of a shelf load-supporting device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a shelf load-supporting device that reinforces wire closet shelves subjected to the cumulative weight of hanging garments. There also exists a long-felt need in the art for a shelf load-supporting device that can be easily installed, adjusted, or removed without tools or permanent alteration to existing closet structures. Moreover, there exists a long-felt need in the art for a shelf load-supporting device that enables users to maximize closet storage capacity by minimizing the risk of shelf deflection or collapse.

The present invention, in one exemplary embodiment, is comprised of a shelf load-supporting device. The shelf load-supporting device is a vertical bracing apparatus configured to reinforce and stabilize the front edge or other portions of a wire shelf, typically used in closet systems. The device is designed to counteract sagging, deflection, or structural failure of the shelf caused by the cumulative weight of stored items by transmitting compressive forces from the shelf directly to the floor, thereby improving structural stability and maintaining alignment over time.

The device is comprised of a body that functions as the primary load-bearing component. The body is formed as an adjustable telescopic rod, allowing for extension and retraction to suit a variety of shelf installation heights, accommodating both low and high mounting positions without requiring alteration to existing shelving. At least one integrated locking mechanism secures the telescopic body at the selected length.

A first end of the body includes a non-slip rubber foot designed to ensure stable contact with the floor. The foot may incorporate a concave or domed surface to optimize pressure distribution and may feature grip enhancements such as ridges, treads, chevron patterns, or radial grooves to improve traction on different flooring materials.

The device may include an integrated leveling bubble located near the base or midsection of the body. This feature enables vertical alignment during installation, enhancing axial load transfer and structural effectiveness.

A second end of the body is comprised of at least one receiving structure configured to engage the underside of the wire shelf. The receiving structure is formed as a cradle-like bracket shaped to conform to the shelf. Retention features may also be included to improve mechanical engagement with the shelf and to secure the device in place, especially in conditions involving vibration or incidental contact.

The invention also encompasses a method of use involving placement of the device beneath the shelf, extension of the telescopic body to engage the shelf, actuation of the locking mechanism, visual alignment using the leveling bubble, and securing of the receiving structure using at least one retention feature to ensure a stable connection.

As a result, the shelf load-supporting device described herein offers an adjustable solution that transmits vertical loads directly from the shelf to the floor. The inclusion of a rubber foot enhances stability across multiple flooring surfaces, while the upper fixture securely interfaces with the underside of the shelf rib to prevent displacement. The telescopic feature accommodates varying shelf heights, supporting a broad range of garment sizes. The locking mechanism maintains the desired extension, and the optional leveling component aids in proper installation. Protective and retention elements at the upper end safeguard the shelf and improve load-bearing engagement. As such, the device provides a non-permanent, tool-free means of reinforcing shelf structures, increasing the functional reliability of residential and commercial closet systems.

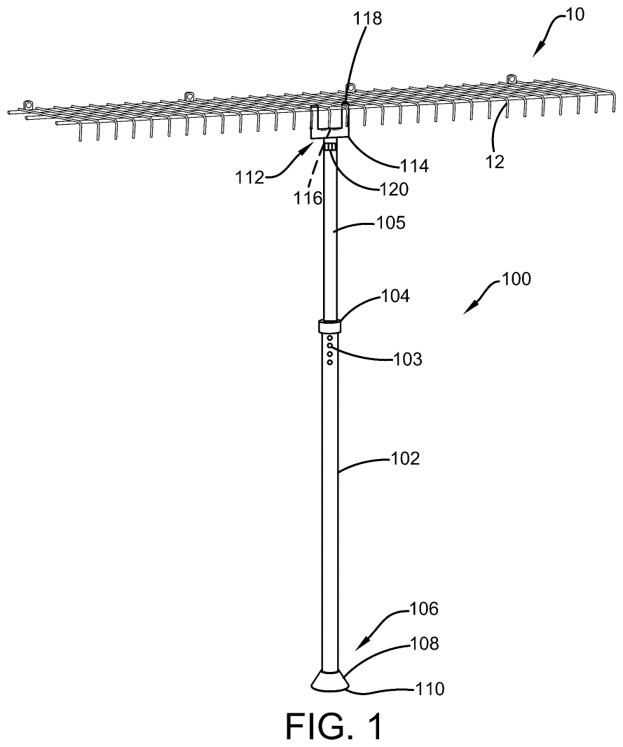

Referring initially to the drawings, FIG. 1 illustrates a perspective view of one potential embodiment of a shelf load-supporting device 100 of the present invention while attached to a shelf in accordance with the disclosed architecture. The shelf load-supporting device 100 is a vertical bracing apparatus configured to reinforce and stabilize the front edge 12 (and/or other area) of a wire shelf 10 that are typically installed in residential or commercial closet systems. The device 100 is specifically configured to address structural sagging, deflection, or potential failure of the wire shelf 10 that may result from the cumulative weight of hanging garments, hangers, and other stored objects. The device 100 functions by transmitting the compressive load from the underside of the shelf 10 directly to the floor surface, thereby increasing the structural resilience of the shelf 10 and maintaining alignment over prolonged use.

The device 100 is comprised of a body 102, which serves as the primary load-transmitting structure. The body 102 is preferably constructed as an adjustable telescopic rod, allowing for selective extension and retraction to adapt to a range of shelf installation heights. The telescopic function of the body 102 accommodates both low-mounted and high-mounted shelf configurations, enabling a versatile installation process without modification to existing shelving.

The body 102 may be fabricated from tubular materials such as, but not limited to, aluminum alloy, powder-coated steel, or carbon fiber, with either a round or square cross-section. The square cross-section offers improved resistance to torsional rotation, while the round configuration may facilitate easier manual adjustment. At least one locking mechanism 104 is integrated into the body 102 to permit secure retention at a selected extended length. The locking mechanism 104 may include, but is not limited to, a twist-lock collar that engages via radial compression between telescoping segments or a push-button pin system that aligns with a series of detents and/or through-holes 103 along the outer surface 105 of the body 102 to maintain fixed positioning.

A first end 106 of the body 102 may be comprised of a non-slip rubber foot 108 (as seen in FIG. 1), which provides stable and secure contact with the floor surface. The foot 108 may feature a slightly concave or domed contact surface to optimize pressure distribution and increase the contact area for improved grip. The foot 108 may further include grip enhancements 110 such as, but not limited to, ridges, treads, chevron patterns, or radial grooves to reduce lateral movement and increase traction on flooring materials such as tile, wood, laminate, or carpet.

The device 100 may include an integrated leveling bubble 120 near the base or midsection of the body 102, which allows a user to ensure that the device is vertically plumb during installation. This feature improves structural performance by ensuring proper axial load transfer.

A second end 112 of the body 102 is comprised of at least one receiving structure 114 configured to engage the underside of the wire shelf 10. The receiving structure 114 is preferably formed as a cradle-like bracket, dimensioned and contoured to interface with the shelf 10. To prevent metal-on-metal contact or abrasion, the receiving structure 114 may incorporate a protective interface 116 made from an elastomeric material such as rubber or silicone. This interface 116 may be over-molded, adhesively bonded, or mechanically fastened to the bracket surface to prevent movement and preserve the finish of the shelf 10 during use.

The receiving structure 114 may optionally include one or more retention features 118 configured to enhance the mechanical engagement between the shelf 10 and the structure 114. These retention features 118 may include, but are not limited to, a spring-loaded clip that clamps onto the wire shelf rib, a flexible latch that snaps over the shelf element, or a hook and loop fastener such as a hook and loop strap that wraps around the shelf frame. The inclusion of these features 118 may be particularly advantageous in high-traffic areas or installations subject to vibration, incidental contact, or shifting loads.

To install the shelf load-supporting device 100, a user places the rubber foot 108 on the floor directly beneath the target shelf 10, as seen in FIG. 1. The user then extends the telescopic body 102 upward until the receiving structure 114 seats securely beneath the front support rib of the wire shelf 10. Once the desired height is achieved, the locking mechanism 104 is actuated to fix the telescopic body 102 in place. The installation process does not require tools or permanent modifications, enabling rapid deployment, repositioning, or removal by users such as renters, DIY users, or those regularly reconfiguring closet spaces.

In operation, the shelf load-supporting device 100 serves as a structural intermediary between the shelf 10 and the floor, carrying vertical loads and reducing mechanical stress on wall-mounted supports and brackets. By minimizing vertical deflection and eliminating forward sag, the device 100 contributes to long-term shelf stability, improves user confidence in shelf performance, and preserves the visual alignment and appearance of the closet system.

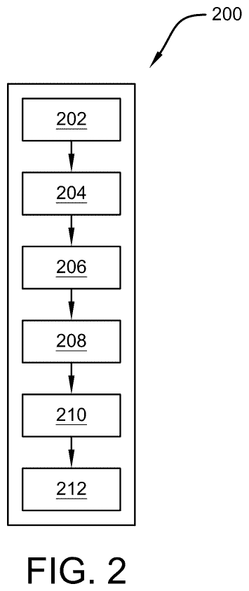

The present invention is also comprised of a method of using 200 the device 100, as seen in FIG. 2. First, a device 100 is provided comprised of a body 102 comprised of at least one locking mechanism 104, at least one rubber foot 108 located at a first end 106 of the body 102, and at least one receiving structure 114 located at a second end 112 of the body 102 [Step 202]. Then, the rubber foot 108 can be placed onto a floor surface directly beneath a wire shelf 10 intended for reinforcement [Step 204]. Next, the body 102 can be telescopically extended until the receiving structure 114 engages the underside of the wire shelf 10 [Step 206]. Then, the locking mechanism 104 can be actuated to secure the body 102 at the desired extended length [Step 208]. Next, the user can visually confirm vertical alignment of the body 102 using a leveling bubble 120 integrated into the body 102 [Step 210]. Finally, the receiving structure 114 can be adjusted or secured using at least one retention feature 118 to ensure stable engagement with the wire shelf 10 [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “shelf load-supporting device” and “device” are interchangeable and refer to the shelf load-supporting device 100 of the present invention.

Notwithstanding the foregoing, the shelf load-supporting device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the shelf load-supporting device 100 as shown in the FIGS. are for illustrative purposes only, and that many other sizes and shapes of the shelf load-supporting device 100 are well within the scope of the present disclosure. Although the dimensions of the shelf load-supporting device 100 are important design parameters for user convenience, the shelf load-supporting device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A shelf load-supporting device comprising:
a telescopic body comprised of a first end and a second end, wherein the telescopic body is selectively extendable and retractable;
a locking mechanism integrated into the telescopic body and configured to retain the telescopic body at a selected extended length;
a foot located at the first end of the telescopic body and configured to contact a floor surface; and
a receiving structure located at the second end of the telescopic body.

2. The shelf load-supporting device of claim 1, wherein the foot is comprised of a domed foot or a concave foot.

3. The shelf load-supporting device of claim 1, wherein the foot is comprised of a ridge, a tread, a pattern, or a groove.

4. The shelf load-supporting device of claim 1, wherein the receiving structure is comprised of a bracket.

5. The shelf load-supporting device of claim 1, wherein the receiving structure is comprised of a protective interface.

6. The shelf load-supporting device of claim 1, wherein the telescopic body is comprised of a locking mechanism.

7. The shelf load-supporting device of claim 6, wherein the locking mechanism is comprised of a twist-lock collar or a push-button pin system.

8. The shelf load-supporting device of claim 1, wherein the receiving structure is comprised of a retention feature.

9. The shelf load-supporting device of claim 1, wherein the retention feature is comprised of a spring-loaded clip.

10. The shelf load-supporting device of claim 1, wherein the retention feature is comprised of a latch.

11. The shelf load-supporting device of claim 1, wherein the retention feature is comprised of a hook and loop fastener.

12. A shelf load-supporting device comprising:
a telescopic body comprised of a first end and a second end, wherein the telescopic body is selectively extendable and retractable;
a locking mechanism integrated into the telescopic body and configured to retain the telescopic body at a selected extended length;
a leveling bubble;
a foot located at the first end of the telescopic body and configured to contact a floor surface; and
a receiving structure located at the second end of the telescopic body.

13. The shelf load-supporting device of claim 12, wherein the foot is comprised of a domed foot or a concave foot.

14. The shelf load-supporting device of claim 12, wherein the foot is comprised of a ridge, a tread, a pattern, or a groove.

15. The shelf load-supporting device of claim 12, wherein the receiving structure is comprised of a bracket.

16. The shelf load-supporting device of claim 12, wherein the receiving structure is comprised of a protective interface.

17. The shelf load-supporting device of claim 12, wherein the telescopic body is comprised of a locking mechanism.

18. The shelf load-supporting device of claim 12, wherein the receiving structure is comprised of a retention feature.

19. The shelf load-supporting device of claim 12, wherein the retention feature is comprised of a spring-loaded clip.

20. A method of using a shelf load-supporting device, the method comprising the following steps:
providing a shelf load-supporting device comprised of a telescopic body, a locking mechanism, a foot located at a first end of the body, and a receiving structure located at a second end of the body;
placing the foot onto a floor surface directly beneath a shelf;
extending the telescopic body until the receiving structure engages an underside of the shelf;
actuating the locking mechanism to secure the telescopic body at a selected extended length; and
securing the receiving structure using a retention feature to ensure stable engagement with the shelf.
